(19) United States
(12) Patent Application Publication
(10) Pub. No.: US 2025/0168638 A1
(43) Pub. Date: May 22, 2025

(54) PERSONAL INTERNET OF THINGS NETWORK CONNECTIVITY

(71) Applicant: INTERDIGITAL PATENT HOLDINGS, INC., Wilmington, DE (US)

(72) Inventors: Xiaoyan Shi, Lake Oswego, OR (US); Taimoor Abbas, Sainte-Julie (CA); Anuj Sethi, Ottawa (CA); Debashish Purkayastha, Eagleville, PA (US)

(73) Assignee: INTERDIGITAL PATENT HOLDINGS, INC., Wilmington, DE (US)

(21) Appl. No.: 18/833,692

(22) PCT Filed: Jan. 27, 2023
(86) PCT No.: PCT/US2023/011734

§ 371 Date: Jul. 26, 2024

Related U.S. Application Data
(60) Provisional application No. 63/303,832, filed on Jan. 27, 2022.

(51) Int. Cl. H04W 12/08; H04W 12/37

(52) U.S. Cl. CPC H04W 12/08; H04W 12/37

(57) ABSTRACT

Methods, devices, and systems for personal internet of things (PIN) networking are provided. A wireless transmit/receive unit (WTRU) is described having circuitry for: sending a PIN policy request indicating a PIN manager capability to a core network (CN); receiving a PIN policy from the CN indicating authorized PIN types; sending a PIN connectivity policy indicating a PIN gateway (GW) capability of the WTRU; receiving PIN connectivity policy information that indicates traffic forwarding parameters, a data network name (DNN), and slice information from the CN; receiving a PIN connectivity establishment request from a PIN element; establishing a connection with the CN based on the DNN and the slice information; and forwarding data between the CN and the PIN element, via the connection, based on the traffic forwarding parameters.

### CROSS-REFERENCE TO RELATED APPLICATIONS

This application claims the benefit of U.S. Provisional Application No. 63/303,832, filed Jan. 27, 2022; the contents of which are incorporated herein by reference.

### BACKGROUND

Internet of Things (IoT) is a term which can be used to describe a network of devices embedded with sensors or other capabilities. IoT devices typically communicate data via a wireless or wired communications network.

### SUMMARY

Methods, devices, and systems for personal internet of things (PIN) networking are provided. A wireless transmit/receive unit (WTRU) is described having circuitry for: sending a PIN policy request indicating a PIN manager capability to a core network (CN); receiving a PIN policy from the CN indicating authorized PIN types; sending a PIN connectivity policy indicating a PIN gateway (GW) capability of the WTRU; receiving PIN connectivity policy information that indicates traffic forwarding parameters, a data network name (DNN), and slice information from the CN; receiving a PIN connectivity establishment request from a PIN element; establishing a connection with the CN based on the DNN and the slice information; and forwarding data between the CN and the PIN element, via the connection, based on the traffic forwarding parameters.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a system diagram illustrating an example Personal IoT Network (PIN);

FIG. 3 is a system diagram illustrating another example PIN;

FIG. 4 is a system diagram illustrating an example PIN architecture;

FIG. 5 is a system diagram illustrating an example architecture for a 5G residential network;

FIG. 6 is a flow chart illustrating an example method for a PEMC establishing connectivity;

FIG. 7 is a flow chart illustrating an example method for a PIN GW establishing connectivity;

FIG. 8 is a sequence chart illustrating example communications for PIN connectivity establishment;

FIG. 9 is a flow chart illustrating an example method for a PEMC/GW establishing connectivity;

FIG. 10 is a sequence chart illustrating example communications for connectivity establishment;

FIG. 11 is a sequence chart illustrating example communications for local connectivity establishment; and

FIG. 12 is a sequence chart illustrating example communications for connectivity establishment.

### DETAILED DESCRIPTION

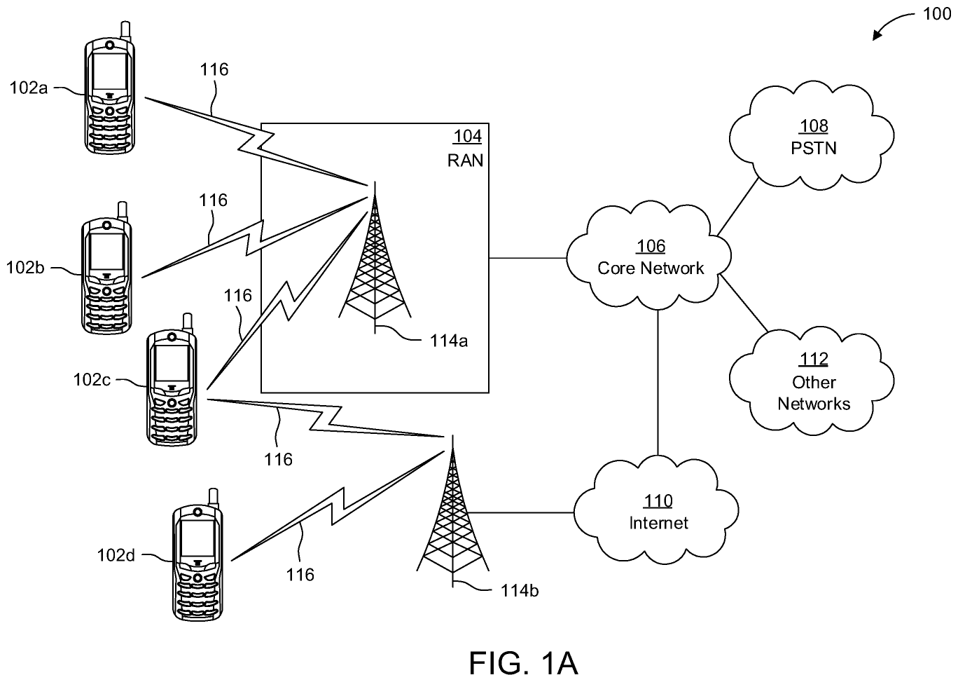

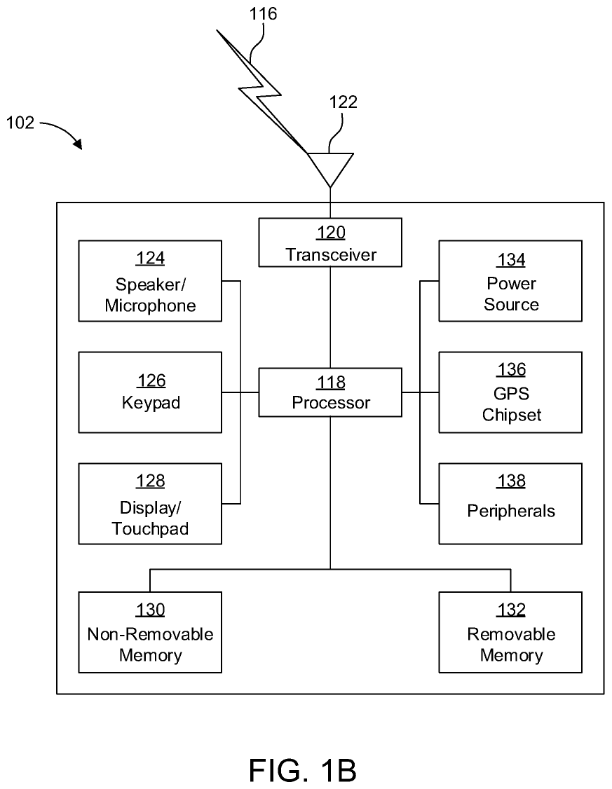

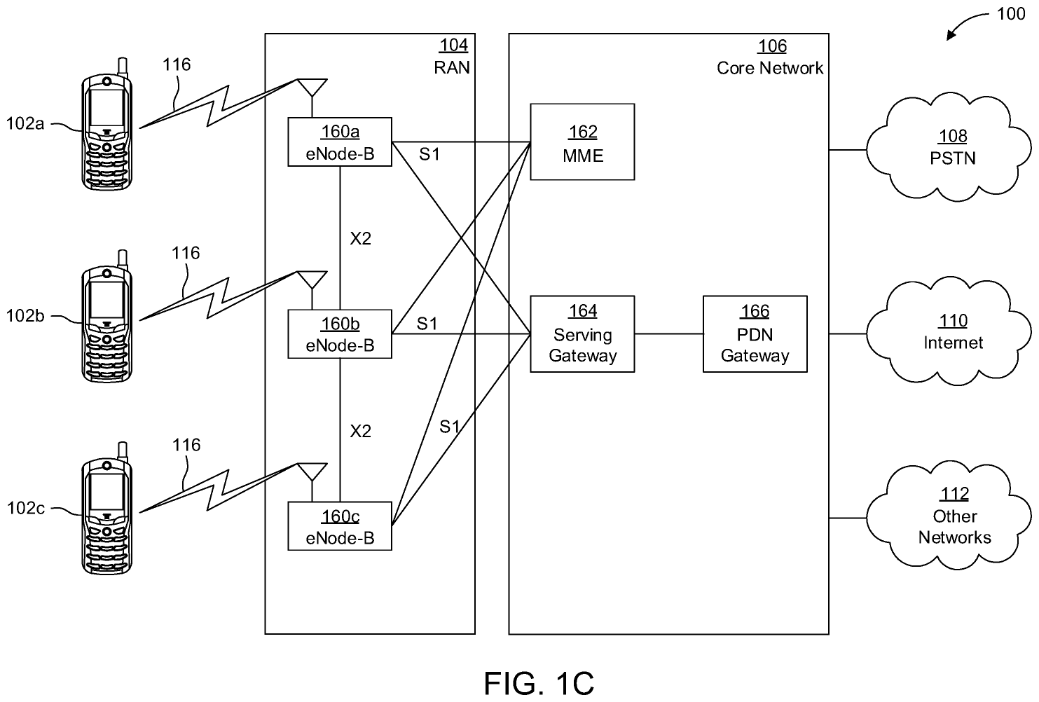

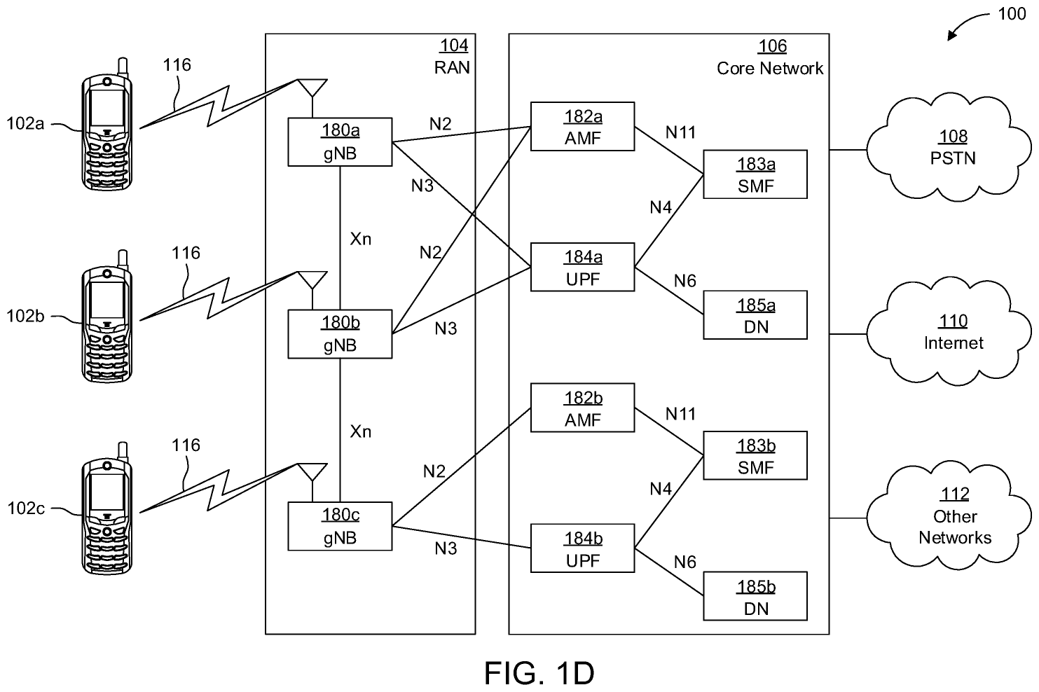

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Internet of Things (IoT) features have been designed for devices that communicate using the traditional cellular network. Devices with IoT features typically have better power consumption performance (e.g., as compared with a typical UE) and increased network efficiency for bulk operations. IoT features may include, for example, Control Plane Cellular IoT (CIoT) 5GS optimization, power saving enhancements, and so forth.

In some embodiments, e.g., where multiple IoT devices deployed in a private environment, WTRUs with IoT capabilities can be organized as Personal IoT Network (PIN). For example, in a home environment, security sensors, smart lights, smart plugs, printers, cellphones, etc. may be managed by a residential gateway, and may communicate with each other. In some embodiments, these home devices can form parts of a PIN. Each device in a PIN may be referred to as a PIN element. Different PIN elements may have different capabilities. For example, a residential gateway or other device and/or application configured to provide connections between PIN elements, and connections between the 5G network (or other network) and PIN Elements may be referred to as a PIN element with Gateway Capability (PIN GW). In some embodiments, an IoT device (e.g., PIN element) may communicate directly with other PIN elements, or via a PIN GW, or via another network (e.g., 5G, or internet via 5G). In some embodiments, a PIN is a specific LAN which is controlled by a CN (e.g., a 5G system). In some embodiments, PIN management (e.g., PEMC) and PIN GW are WTRUs (e.g., UEs) which can access a CN (e.g., 5G CN).

In some embodiments, a residential gateway may provide management functions for the PIN. A PIN element or other device and/or application which provides PIN management functionality may be referred to as a PEMC, PIN Management, or a PIN element with management capability (PEMC). Example management functions for the PIN include creating, modifying, or deleting a PIN, authorizing or deauthorizing a PIN element to access a PIN, authorizing or deauthorizing a PIN element to access another network (e.g., 5G CN) via a PIN GW, and so forth. A PIN GW may be collocated with a PEMC in some embodiments.

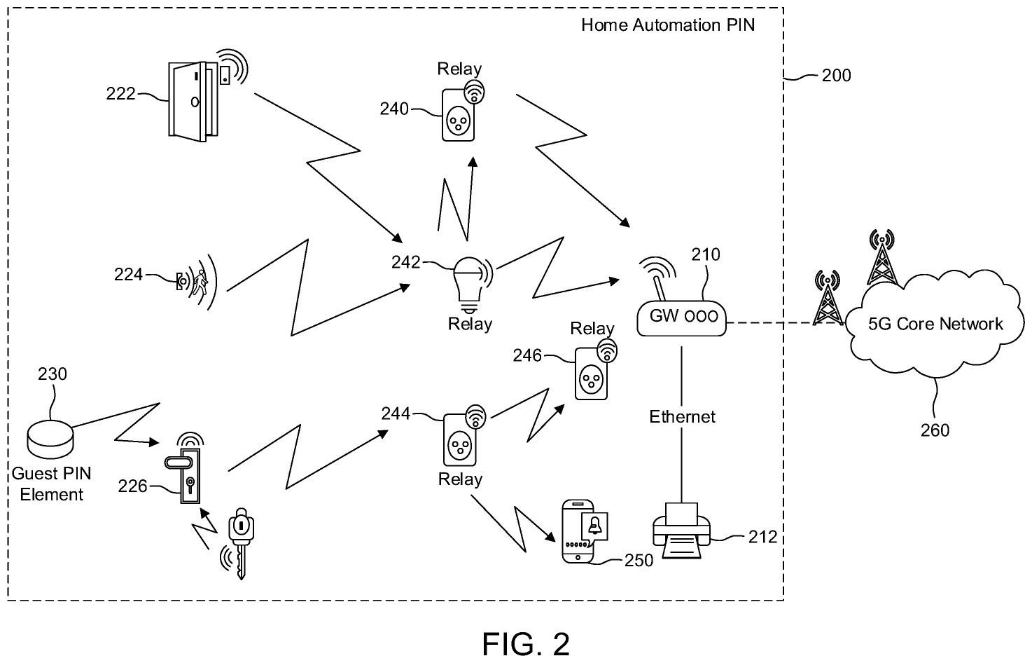

FIG. 2 is a system diagram illustrating an example PIN 200. In this example, the PIN 200 is a home automation PIN. In other embodiments, a PIN may be usable for any suitable purpose. The exemplary PIN 200 of FIG. 2 includes a gateway 210 (which in embodiments may be a residential gateway) serving as PIN GW and various other PIN elements, such as smart doors 222, alarm systems 224, smart lights 242, smart power outlets 240, 244, 241 smart locks 226, guest PIN elements 230, and so forth. Some of the PIN elements may serve as relays, as shown, for example, by smart outlets 240, 244, 246, and smart light 242. In this example, the PIN GW includes a PIN management function (i.e., it is a PEMC). The PIN GW may be connected to a local ethernet and to devices connected to the local ethernet, for example, a printer 212. A WTRU 250, which may be a mobile phone, may also be part of the PIN 200. The PIN may be connected to a core network 260, which may be a 5G CN.

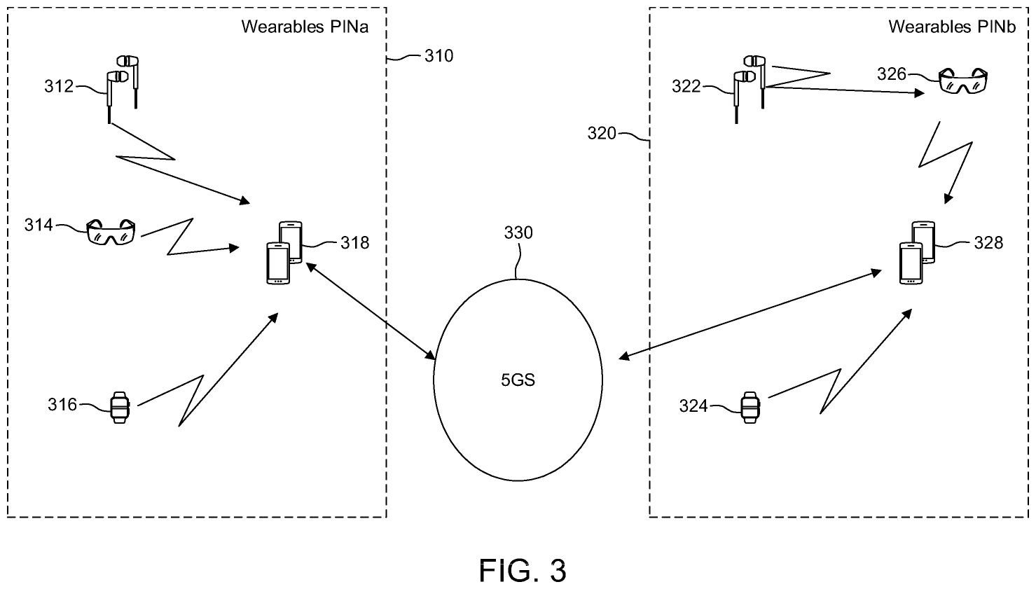

FIG. 3 is a system diagram illustrating another example PIN. The example of FIG. 3 includes a wearables PIN, PINa 310. PINa includes a WTRU, which may be a cellphone 318 or smartphone serving as PIN GW and PEMC, and various PIN elements, such as a smart watch 316, virtual reality (VR) and/or augmented reality (AR) glass 314, and wireless headphones 312. Any suitable wearable (or non-wearable) PIN elements may be included in a wearables PIN in other embodiments. The PIN elements (including the cellphone or smartphone) communicate with each other within the PIN (or with other devices, such as WTRUs or UEs via a 5G network 330). In some embodiments, PINa may communicate with a similar PIN (PINb) 320 via the 5G network. PINb may include a WTRU, which may be a cellphone 328 or smartphone serving as PIN GW and PEMC, and various PIN elements, such as a smart watch 324, virtual reality (VR) and/or augmented reality (AR) glass 326, and wireless headphones 322. In some embodiments, PINa 310 and PINb 320 communicate via any suitable communications infrastructure and/or protocol, such as 5G, LTE, WiFi, TCP/IP, Internet, and so forth.

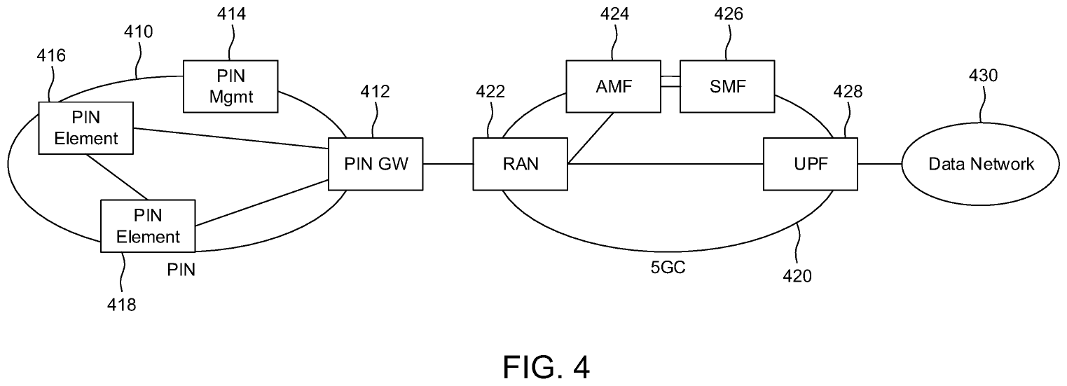

FIG. 4 is a system diagram illustrating an example PIN architecture. In the example of FIG. 4, the PIN 410 includes PIN elements 416, 418, a PEMC (PIN Mgmt 414 in the figure), and a PIN Gateway (PIN GW) 412. In this example, a PIN element 416, 418 is a WTRU (e.g., UE) or non-3GPP device that can communicate within a PIN. PIN Mgmt 414 is a PIN element with capability to manage the PIN. PIN GW412 is a PIN element that has the ability to provide connectivity to and from the 5G network 420 for other PIN Elements. Example connectivity includes IP connectivity, Ethernet connectivity, and so forth. Such connectivity may be provided, for example, by creating a PDU session between the PIN GW 412 and a 5G network 420. The 5G network 420 may comprise a RAN 422, an AMF 424 and SMF 426 and a UPF 428. Connectivity may be established toward different 5G networks, different DNNs 430, different slicing (e.g., Network Slice Selection Assistance Information (NSSAI), and so forth.

In some embodiments, PIN elements may communicate each other via the PIN GW, or directly. In some embodiments, PIN elements may communicate with a 5G system to obtain 5G service and/or to communicate with a data network via the 5G core network. A 5GC is used for example, however, any suitable core network is usable in other embodiments. PIN elements may communicate with any other suitable system to obtain corresponding service and/or communicate with a data network via the 5GC. In this example, an access and mobility management function (AMF) 424, session management function (SMF) 426, and user plane function (UPF) 428 of the 5GC are shown, and other elements are omitted for ease of illustration.

In some embodiments, an existing 5G RG provides IP connectivity for local devices. In some embodiments, a PIN element may have a specific connectivity requirement, e.g., may require a specific DNN. In some embodiments, the PIN is managed by a PEMC, but connectivity is controlled by a PIN GW.

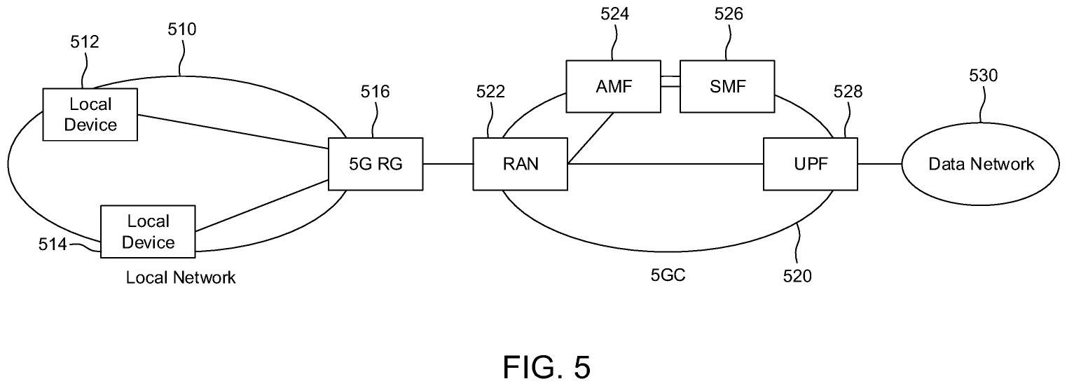

FIG. 5 is a system diagram illustrating an example architecture for a 5G residential network 510. In this example, the 5G residential network includes a 5G residential gateway (RG) 516, and local devices 512, 514, which may include WTRUs or other devices that can communicate with the 5G RG 516 over a local network. In this example, the local network 510 is IP based, however any suitable communications infrastructure may be usable in other embodiments. The local network 510, via the 5G RG 516, may provide connectivity between local devices and the 5G system to obtain 5G service and/or to communicate with a data network via the 5G core network 520. The 5G network 520 may comprise a RAN 522, an AMF 524 and SMF 526 and a UPF 528. Connectivity may be established toward different 5G networks, different DNNs 530, different slicing (e.g., Network Slice Selection Assistance Information (NSSAI), and so forth.

In the exemplary 5G residential network of FIG. 5, the 5G RG 516 establishes a PDU session with the 5GC to obtain IP addresses and/or prefixes. After obtaining the IP addresses and/or prefixes, the 5G RG allocates IP addresses and/or prefixes to local devices. After being allocated IP addresses and/or prefixes local device may communicate with other devices or the data network via IP traffic.

A PIN may provide connectivity between PIN elements and a 5G system by a mechanism used in residential networks; e.g., via a PDU session established by a residential gateway, however various complicating issues may remain. For example, legacy systems may not provide CN connectivity management (e.g., management of connections between PIN GW and 5GC, or between PIN elements and 5GC via PIN GW) and/or local connectivity management (e.g., management of connections between PIN elements and other PIN elements, and/or between PIN elements and PN GW).

Various PINs may include PIN elements of different types; e.g., security sensors, Bluetooth earbuds, game consoles, VR glasses, smart TVs, and so forth. Different PINs and PIN elements may have different connectivity requirements. For example, some PINs or PIN elements may require access to 5G service and/or an external data network, whereas some PINs or PIN elements may only utilize internal communications (i.e., within in the PIN). In other words, some PINs and PIN elements require 5G service or access to external networks via 5G, whereas other PIN elements only require internal communications within the PIN.

Accordingly, some embodiments facilitate authorization for a PIN and/or PIN elements to use CN connectivity (e.g., to communicate between PIN GW and 5GC, or between PIN elements and 5GC via PIN GW). Some embodiments may facilitate differentiation of PINs and/or PIN elements to provide CN connectivity.

Various PIN elements may use local connectivity (e.g., communicate between PIN elements and/or with the PIN GW) to communicate with or via other PIN elements or the 5GC via the PIN GW. Accordingly, some embodiments may facilitate authorization for PIN and PIN element local connectivity (i.e., between PIN elements and/or with the PIN GW). For example, besides the IP allocation as used in a residential network, the PIN GW may be configured to identify whether a PIN element is authorized to use local connectivity.

Various challenges may include authorization of PIN connectivity, provision of connectivity between PIN and Core network, and provision of connectivity between PIN Elements and a PIN GW.

Accordingly, some embodiments may provide PIN policy provisioning. In some embodiments, a PEMC receives authorized PIN types and corresponding connectivity types (e.g., local connectivity type, or CN connectivity type), PIN size, and/or PIN duration. In some embodiments, a PIN GW receives an authorized PIN type and corresponding connectivity type and corresponding CN connectivity parameters (e.g., DNN, SSC mode, PDU session type).

Some embodiments may provide CN connectivity between a PIN GW and a CN. In some embodiments, a PEMC requests that a PIN GW establish connectivity to a CN for a PIN by indicating the PIN type. In some embodiments, the PIN GW retrieves DNN, SSC mode, and NSSAI for the PIN type. In some embodiments, the PIN GW indicates the PIN ID during a PDU session establishment procedure.

Some embodiments provide local connectivity between PIN elements and a PIN GW. In some embodiments, a PIN GW provides security parameters for the connectivity to a PEMC, which configures them to PIN elements. In some embodiments, PIN elements provides their ID, data delivery type and security parameters for connectivity establishment between the PIN element and the PIN GW. In some embodiments, the PIN GW reports PIN element IDs, IPs, and RATs to the CN, e.g., for charging and QoS control. In some embodiments, the PIN GW selects control plane (CP) or user plane (UP) delivery for PIN element traffic according to delivery type.

Some embodiments provide connectivity between a PIN and core network. Some example PIN types include sensor PINs, VR PINs, game PINs, and so forth. Some example connectivity types include local connectivity or CN connectivity. In some embodiments, different PIN types are associated with different requirements for connection to the core network (e.g. SSC mode, slice, DNN, CP data delivery, and so forth). In some embodiments, a PEMC requests the PIN GW to establish a connection to the core network, e.g., by indicating PIN type. In some embodiments, the indication may indicate a PIN elements list and/or corresponding connectivity type.

Some embodiments provide CN connectivity management. For example, in some embodiments, a PEMC and/or PIN GW receives PIN connectivity policy, which includes authorized PIN types, from the 5G system (e.g., AMF or PCF, etc.). In some embodiments, the PIN connectivity policy received from the 5G system may include authorized PIN types, connectivity type of each PIN type, and/or CN connectivity parameters of each PIN type. In some embodiments, when the PEMC requests that the PIN GW establish or modify PIN connectivity for a PIN, the PEMC indicates the PIN type in the request. In some embodiments, after receiving a PIN type in a PIN connectivity establishment or modification request from PIN Management, the PIN GW retrieves connectivity type and CN connectivity parameters of the PIN type based on the received PIN connectivity policy. In some embodiments, the PIN GW establishes or modifies CN connectivity with the 5G core network based on the retrieved CN connectivity parameters.

In some embodiments, the PIN type may indicate a type of the whole PIN. For example, PIN types may include a sensor PIN, VR PIN, game PIN and so forth. In some embodiments, the PIN GW establishes or modifies CN connectivity with the 5G core network for the whole PIN (e.g., based on the PIN type). Alternatively, in some embodiments, the PIN type may indicate a type of PIN elements (a type of parts of a PIN, or a partial PIN). For example, PIN types for PIN elements may include motion sensor, VR glass, game console, and so forth. In some embodiments, when a PIN type represents a PIN element type, the PIN GW may establish or modify CN connectivity with the 5G core network for the type of PIN element (for parts of a PIN, or a partial PIN).

In some embodiments, the connectivity type may indicate local connectivity (i.e., intra-PIN communication), CN connectivity (i.e., communication via 5G core network or other CN), offload connectivity (communication with another network via PIN GW offload) and so forth, and/or any combination of these types of connectivity. In some embodiments, the PIN GW establishes or modifies CN connectivity with the 5G core network where a received connectivity type indicates CN connectivity or both CN connectivity and another type of connectivity.

In some embodiments, the CN connectivity parameters may indicate Public Land Mobile Network (PLMN) identity (ID), data network name (DNN), service and session continuity (SSC) mode, slicing information, packet data unit (PDU) session type, data delivery mode (e.g., Control Plane and/or User Plane) and/or data transmission frequency, and so forth.

In some embodiments, the PEMC and/or PIN GW may receive a PIN connectivity policy, which may include local connectivity parameters, from the 5G system (e.g., AMD, PCF, etc.). In some embodiments, the local connectivity parameters may indicate e.g., L2/L3 relay, end point identifiers, inter-RAT communication policy. The local connectivity parameters may be applied to the whole PIN, or per PIN element, or to a group of PIN elements. Different policies may be used in a PIN for different PIN elements. In some embodiments, the PIN GW retrieves receive local connectivity parameters for local connectivity when receiving a PIN connectivity establishment or modification request from the PEMC (e.g., as part of the request, or otherwise indicated by the request).

In some embodiments, before the PIN GW establishes CN connectivity with 5G core network, the PIN GW may select a PLMN for the CN connectivity with the 5G core network. In some embodiments, the PIN GW may establish multiple CN connections with different PLMNs for different PIN types.

In some embodiments, the CN connection with the 5G core network established by the PIN GW may include a PDU session, public data network (PDN) connection, 5G local area network (5G-LAN) connection, short message service (SMS) connection, etc.

In some embodiments, the PIN GW may indicate a PIN ID, PIN type, and/or number of PIN elements in the PIN in the request to establish CN connectivity with 5G core network. In some embodiments, the PIN GW may send a PIN connectivity response to the PEMC to indicate the result of PIN connectivity establishment (e.g., whether the connection was successfully established or failed).

In some embodiments, the PEMC may receive an indication of a connectivity type for each PIN type in a PIN connectivity policy from the 5G system. In some embodiments, when the PEMC requests that the PIN GW establish or modify PIN connectivity for a PIN, the PEMC may indicate connectivity type in the request. In some embodiments, the PIN GW may determine whether to establish or modify CN connectivity with the 5G core network based on received connectivity type.

In some embodiments, the PEMC may receive another PIN policy; e.g., indicating PIN size and/or PIN duration. In some embodiments, PIN size indicates a maximum number of PIN elements in the PIN. In some embodiments, PIN duration indicates a time during which the PIN is available (e.g., to be created, or to be accessed by a PIN element).

In some embodiments, the PEMC may receive a PIN connectivity policy from the PIN GW instead of from 5G system. In some such cases, the PIN GW may request both a PIN connectivity policy for the PEMC and for the PIN GW itself from 5G system.

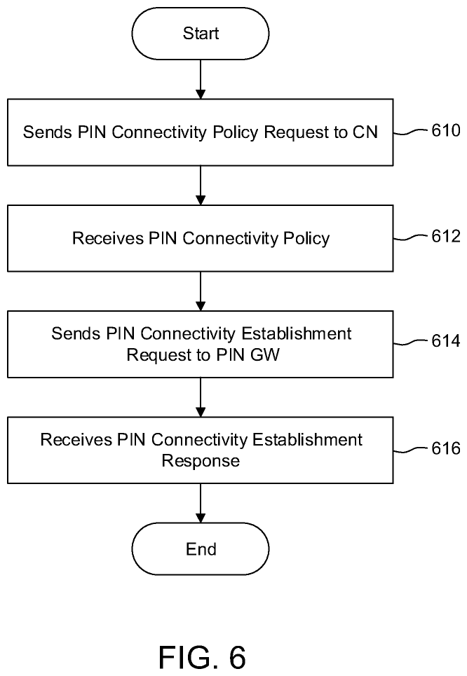

FIG. 6 is a flow chart illustrating an example method for a PEMC to establish connectivity. In this example, at 610, the PEMC sends a PIN connectivity policy request to the CN (e.g. to the AMF or policy control function (PCF) of the CN) or to the PIN GW, where the policy request indicates a PEMC capability. The capability indication may indicate, for example, whether the PIN supports PIN management, e.g., PIN creation, PIN modification, and/or PIN deletion, etc. At 612, the PEMC receives a PIN connectivity policy from the CN or PIN GW, which indicates an authorized PIN type, and a connectivity type of each PIN type. At 614, the PEMC sends a PIN connectivity establishment or modification request to the PIN GW, which indicates an authorized PIN type, and a connectivity type of each PIN type. At 616, the PEMC receives a PIN connectivity establishment or modification response from the PIN GW.

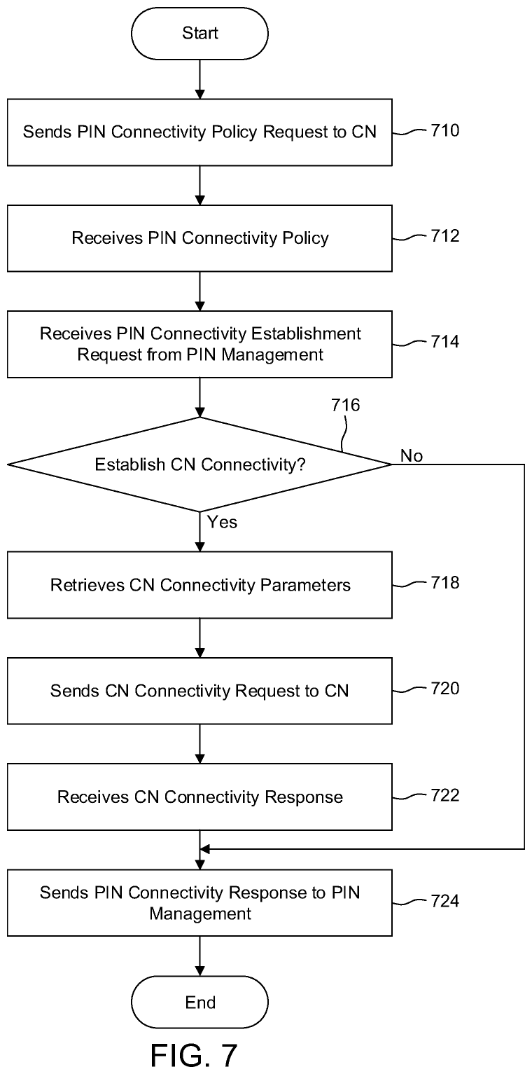

FIG. 7 is a flow chart illustrating an example method for a PIN GW establishing connectivity. In this example, at 710, the PIN GW sends a PIN connectivity policy request to the CN (e.g. to the AMF or policy control function (PCF) of the CN), where the policy request indicates PIN GW capability. At 712, the PIN GW receives a PIN connectivity policy from the CN, which may indicate an authorized PIN type, connectivity type of each PIN type, and/or CN connectivity parameters of each PIN type. At 714, the PIN GW receives a PIN connectivity establishment/modification request from PIN Management, which may indicate an authorized PIN type and/or connectivity type of each PIN type. On a condition (716) that the PIN GW decides to establish CN connectivity, at 718 the PIN GW retrieves a connectivity type of each PIN type, and/or CN connectivity parameters of each PIN type, based on received PIN type and received PIN connectivity policy. The PIN GW determines CN connectivity to be established for the PIN based on connectivity type. The PIN GW selects the 5G core network according to PLMNs in CN connectivity parameters for the PIN type, if applicable. At 720, the PIN GW sends a CN connectivity establishment request to a 5G core network which indicates retrieved CN connectivity parameters, e.g. DNN, SSC mode, and/or slicing info, etc. the Optionally, the PIN GW indicates a PIN type and/or PIN size in the CN connectivity establishment request to the 5G core network. At 722, the PIN GW receives a CN connectivity response from the CN. At 742, the PIN GW sends a PIN connectivity establishment or modification response to the PEMC. This response would also be sent in the event that the result of the determination to establish CN connectivity 716 was negative.

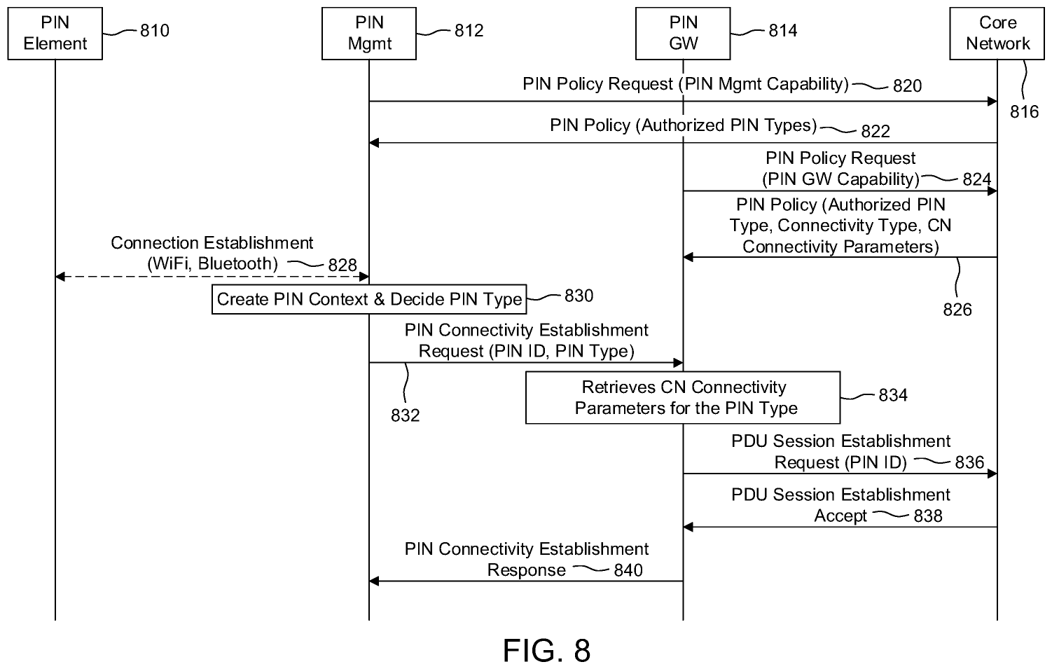

FIG. 8 is a sequence chart illustrating example communications between a PIN Element 810, a PEMC 812, A PIN GW 814 and the CN 816 for PIN connectivity establishment.

At 820, the PEMC 812 communicates (e.g., sends a message indicating) a PIN connectivity policy request to the core network 816 (e.g. to the AMF or policy control function (PCF) of the CN). The message may indicate a PEMC capability.

At 822, the core network 816 communicates (e.g., sends a message indicating) a PIN connectivity policy to the PEMC 812. The message may indicate an authorized PIN type.

At 824, the PIN GW 814 communicates (e.g., sends a message indicating) a PIN connectivity policy request to the core network 816 (e.g. to the AMF or policy control function (PCF) of the CN). The message may indicate a PIN GW capability.

At 826, the core network provides (e.g., sends a message indicating) a PIN connectivity policy to the PIN GW. The message may indicate an authorized PIN type, connectivity type, and/or CN connectivity parameters. In embodiments, operations 824 and 826 may be independent of operations 820 and 822, and may be performed, before, during, or interspersed with operations 820 and 822.

At 828, a PIN element 810 may establish a connection with the PEMC 812. The connection may be any suitable connection, such as, for example, a Bluetooth or WiFi connection. Operation 828 may be performed after operations 820 and 822 in some embodiments. Operation 828 may be performed, e.g., earlier or later than operation 830 in some embodiments. Operation 828 is shown as optional in the figure. Other operations or elements may also be optional in some embodiments. For example, in some embodiments, PEMC 812 may create a PIN context locally and request PIN GW 814 to establish connectivity for the PIN, and then the PEMC 812 waits for PIN elements 810 to join. In another example, after a PIN element 810 joins the PIN, the PEMC 812 requests the PIN GW 814 to establish connectivity. Those of skill in the art will understand that various orderings of these operations are contemplated and that the order of operations shown in FIG. 8 is not intended to be limiting.

At 830, the PEMC 812 determines to create a PIN and determines the PIN type. The PEMC may validate whether the PIN type is allowed (e.g., per the PIN connectivity policy), whether a number of PIN elements to be included in the PIN has reached a PIN size limitation, whether a PIN duration has expired etc. Creating the PIN may include determining and/or storing PIN context information (e.g., PIN ID, list of PIN elements, PIN types, and so forth).

At 832, the PEMC 812 communicates (e.g., sends a message indicating) a PIN connectivity establishment request to the PIN GW 814. The communication may indicate the PIN ID and PIN type for the PIN to be created. The communication may indicate a number of PIN elements, a PIN elements ID list, and/or a PIN duration, etc.

At 834, the PIN GW 814 determines to establish or modify CN connectivity for the PIN according to the connectivity type of the PIN type indicated in the message of operation 832. The PIN GW 814 retrieves CN connectivity parameters for the PIN type according to the corresponding PIN connectivity policy.

At 836, the PIN GW 814 communicates (e.g., sends a message indicating) a CN connectivity establishment or modification request to the core network 816. The communication may indicate, e.g., a PDU session establishment or modification request. The communication may indicate, e.g., a PIN ID, a PIN type of the PIN, and/or a number of PIN elements.

At 838, the core network 816 communicates (e.g., sends a message indicating) a CN connectivity establishment or modification response to the PIN GW 814. The communication may include, e.g., a PDU session establishment and/or modification response.

At 840, the PIN GW 814 communicates (e.g., sends a message indicating) a PIN connectivity establishment response to the PEMC 812. The communication may indicate the PIN connectivity establishment result; e.g., that CN connectivity is established.

In some embodiments, the PEMC 812 may be collocated with the PIN GW 814. The collocated PEMC and PIN GW may be referred to as a PEMC/GW. The PEMC/GW may receive the PIN connectivity policy from the 5G system, which may include an authorized PIN type, connectivity type of each PIN type, and/or CN connectivity parameters of each PIN type. In some embodiments, when the PEMC/GW decides to create a PIN, the PEMC/GW retrieves connectivity type and CN connectivity parameters of the PIN type according the received PIN connectivity policy. In some embodiments, the PEMC/GW establishes or modifies CN connectivity with 5G core network based on the retrieved CN connectivity parameters.

In some embodiments, the PIN type may indicate a type of the whole PIN. For example, PIN types may include sensor PIN, VR PIN, game PIN and so forth. In some embodiments, the PEMC/GW establishes or modifies CN connectivity with 5G core network for the whole PIN (e.g., based on the PIN type). Alternatively, in some embodiments the PIN type may indicate a type of PIN elements (a type of parts of a PIN, or a partial PIN). For example, PIN types for PIN elements may include motion sensor, VR glass, game console, and so forth. In some embodiments, when a PIN type represents a PIN element type, the PEMC/GW may establish or modifiy CN connectivity with the 5G core network for the type of PIN element (for parts of a PIN, or a partial PIN).

In some embodiments, the connectivity type may indicate local connectivity (i.e., intra-PIN communication), CN connectivity (i.e., communication via 5G core network or other CN), offload connectivity (communication with another network via PIN GW offload) and so forth, and/or any combination of these types of connectivity. In some embodiments, the PEMC/GW establishes or modifies CN connectivity with the 5G core network where a received Connectivity type indicates CN connectivity or both CN connectivity and another type of connectivity.

In some embodiments, the CN connectivity parameters may indicate PLMN ID, DNN, SSC mode, slicing information, PDU session type, data delivery mode (e.g., Control Plane and/or User Plane) and/or data transmission frequency, and so forth.

In some embodiments, before the PEMC/GW establishes CN connectivity with 5G core network, the PEMC/GW may select a PLMN for the CN connectivity with 5G core network. In some embodiments, the PEMC/GW may establish multiple CN connections with different PLMNs for different PIN types.

In some embodiments, the CN connectivity with the 5G core network established by the PEMC/GW may include a PDU session, public data network (PDN) connection, 5G local area network (5G-LAN) connection, short message service (SMS) connection, etc.

In some embodiments, the PEMC/GW may indicate a PIN ID, PIN type, and/or number of PIN elements in the PIN in the request to establish CN connectivity with 5G core network.

In some embodiments, the PEMC/GW may receive another PIN policy; e.g., indicating PIN size and/or PIN duration. In some embodiments, PIN size indicates a maximum number of PIN elements in the PIN. In some embodiments, PIN duration indicates a time during which the PIN is available (e.g., to be created, or to be accessed by a PIN element).

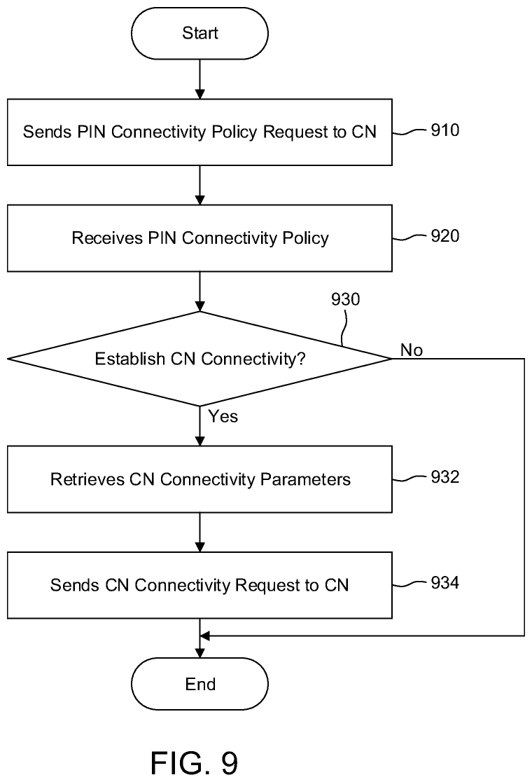

FIG. 9 is a flow chart illustrating an example method for a PEMC/GW establishing connectivity. In this example, at 910 the PEMC/GW sends a PIN connectivity policy request to the CN (e.g. to the AMF or policy control function (PCF) of the CN) or to the PIN GW, where the policy request indicates a PEMC/GW capability. The capability indication may indicate, for example, whether the PIN supports PIN management, e.g., PIN creation, PIN modification, and/or PIN deletion, etc. At 920, the PEMC/GW receives a PIN connectivity policy from the CN, which indicates an authorized PIN type, a connectivity type of each PIN type, and/or CN connectivity parameters of each PIN type. At 930 The PEMC/GW determines whether to establish connectivity with the CN for the PIN based on connectivity type. At 932, the PEMC/GW selects a 5G core network according to PLMNs indicated by the received CN connectivity parameters, if applicable. The PEMC/GW then sends at 934 a CN connectivity establishment request to the 5G core network. The request indicates retrieved CN connectivity parameters 932 (e.g., DNN, SSC mode, slicing info, etc.). In some embodiments, the request indicates the PIN type.

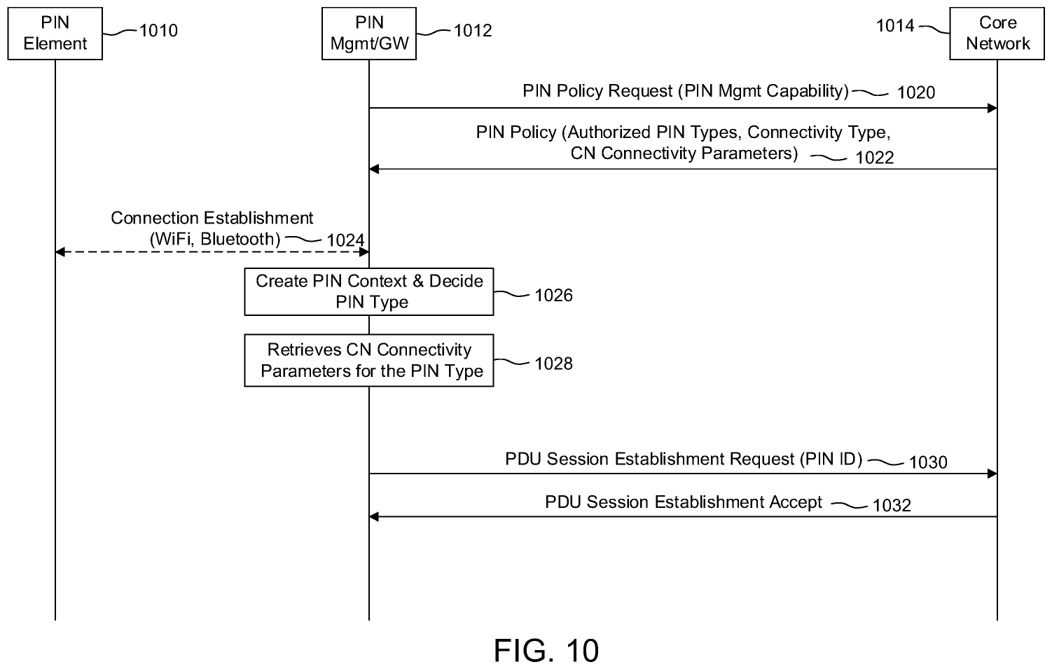

FIG. 10 is a sequence chart illustrating example communications for connectivity establishment between a PIN element 1010, a PIN Management/GW (PEMC/GW) 1012 and a core network 1014.

At 1020, the PIN Management/GW 1012 communicates (e.g., sends a message indicating) a PIN connectivity policy request to the core network 1014 (e.g. to the AMF or policy control function (PCF) of the CN). The message may indicate a PEMC/GW capability.

At 1022, the core network 1014 communicates (e.g., sends a message indicating) a PIN connectivity policy to the PEMC/GW 1012. The message may indicate an authorized PIN type, connectivity type, and/or CN connectivity parameters.

At 1024, a PIN element 1010 establishes a connection with the PEMC/GW 1012. The connection may be any suitable connection, such as a Bluetooth or WiFi connection. Operation 1024 may be optional in embodiments.

At 1026, the PEMC/GW 1012 determines to create a PIN and determines the PIN type. In embodiments, the PEMC/GW may validate whether the PIN type is allowed (e.g., by the PIN connectivity policy), whether a number of PIN elements to be included in the PIN has reached a PIN size limitation, whether a PIN duration has expired, etc.

At 1028, the PEMC/GW 1012 determines to establish or modify CN connectivity for the PIN according to the connectivity type of the PIN type. The PIN Management/GW retrieves CN connectivity parameters for the PIN type according to corresponding PIN connectivity policy

At 1030, the PEMC/GW 1012 communicates (e.g., sends a message indicating) a CN connectivity establishment or modification request to the core network 1014. In embodiments, the message may indicate, e.g., a PDU session establishment or modification request. In further embodiments, the message may indicate, e.g., a PIN ID, a PIN type of the PIN, and/or a number of PIN elements.

At 1032, the core network 1014 communicates (e.g., sends a message indicating) a CN connectivity establishment or modification response to the PEMC/GW 1012. In embodiments, the message may include, e.g., a PDU session establishment and/or modification response.

Some embodiments may provide connectivity between a PIN and a PIN GW. Some embodiments may include security parameters, e.g., for connection establishment between PIN element and PIN GW; PIN GW ID, e.g., used for PIN GW selection; Data delivery type, e.g., indicating control plane delivery or user plane delivery; connectivity type, which may indicate local and/or CN connectivity, and/or IP, Ethernet, or unstructured, etc; and/or PIN Element RAT, e.g., used by CN to decide QoS policy for PIN element's traffic

Some embodiments may provide local connectivity management. For example, in some embodiments, the PEMC provides PIN ID, PIN GW's ID, connectivity type, local connectivity parameters and security parameters for local connectivity to the PIN element. In some embodiments, the PIN element sends a message indicating a local connectivity request to the PIN GW, which includes PIN ID, PIN element's ID, data delivery type, local connectivity parameters, and/or security parameters for local connectivity. In some embodiments, the PIN GW determines whether the requested local connectivity is available, e.g., based on the security parameters for local connectivity. In some embodiments, if the PIN GW accepts the local connectivity request, the PIN GW may send a message indicating a local connectivity response to the PIN element. The message may indicate connectivity status (e.g., whether CN connectivity is available for this local connectivity).

In some embodiments, the PEMC may obtain security parameters for local connectivity from the PIN GW. In some embodiments, the PEMC may obtain security parameters for local connectivity from the core network. In some embodiments, the PEMC may obtain local connectivity parameters from the PIN GW or core network.

In some embodiments, the data delivery type indicated by the local connectivity request may indicate whether data needs to be delivered by control plane or user plane in CN connectivity between PIN GW and 5G core network. In some embodiments, the PIN GW may report the PIN element's ID, IP address used by the PIN element, PIN element's RAT (e.g., Wifi, Bluetooth, etc.) to the core network. In some embodiments, the connectivity status may additionally indicate IP connectivity, Ethernet connectivity, etc. In some embodiments, before sending a local connectivity request to the PIN GW, the PIN element may perform PIN GW discovery and selection based on the received PIN GW ID. PIN GW discovery and selection may include, e.g., proximity discovery. For example, PIN GW may broadcast an announcement message (e.g., including a PIN GW ID in the announcement message) over a radio interface. A PIN element in proximity range may receive this announcement message. The PIN element may be considered to have discovered the PIN GW after having received the announcement message. If the PIN element has discovered multiple PIN GWs, the PIN element may select one PIN GW to access.

In an example method for a PEMC establishing connectivity, the PEMC may receive an indication of security parameters for local connectivity from the PIN GW, and may send an indication of PIN ID, PIN GW's ID, connectivity type and/or security parameters for local connectivity to the PIN element.

In an example method for a PIN element establishing connectivity, the PIN Element may receive an indication of a PIN ID, PIN GW's ID, connectivity type and security parameters for local connectivity from the PEMC. The PIN element may discover and select a PIN GW according to received PIN GW's ID. The PIN element may send an indication of a local connectivity request to the PIN GW, which may include the PIN ID, PIN element's ID, and/or data delivery type. The local connectivity request may be protected by the received security parameters for local connectivity. The PIN element may receive an indication of the connectivity status of the local connectivity.

In an example method for a PIN GW establishing connectivity, the PIN GW may send an indication of the PIN GW's ID and security parameters for local connectivity to the PEMC. The PIN GW may receive a local connectivity request from the PIN element. The PIN GW may determine whether local connectivity corresponding to the local connectivity request is available, based on the security parameters for local connectivity. The PIN GW may send an indication of the connectivity status of the local connectivity to the PIN element. The PIN GW may send an indication of the PIN ID, PIN element's ID, IP address used by the PIN element, and/or PIN element's RAT to the core network. The PIN GW forwards traffic received from the PIN element to the 5G core network by control plane or user plane, e.g., according to data delivery type.

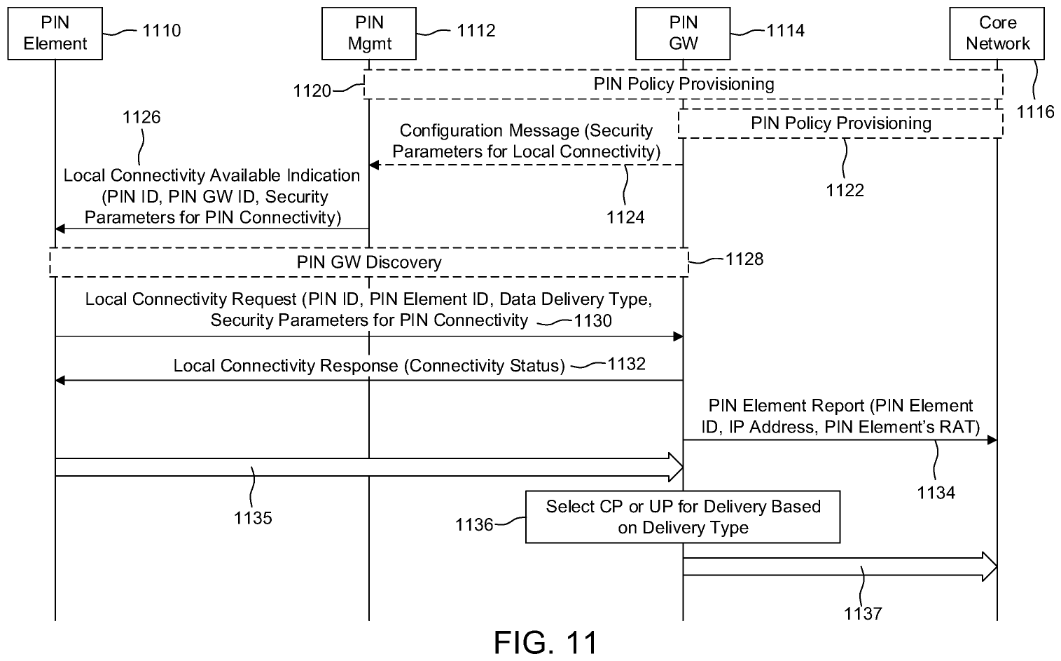

FIG. 11 is a sequence chart illustrating example communications for local connectivity establishment between a PIN element 1110, A PIN management element (PEMC) 1112, a PIN GW 1114 and a core network 1116.

At 1120, the PEMC 1112 receives a PIN connectivity policy for PIN management (e.g., as in operations 820 and 822 in FIG. 8. In some embodiments, the provisioning occurs between PEMC 1112 and the CN (e.g., 5G CN) 1116 without the involvement of the PIN GW 1114. In some embodiments, the PIN connectivity policy for PIN management may include the PIN type. In some embodiments, the PIN connectivity policy for PIN management does not include a CN connectivity parameter.

At 1122, the PIN GW 1114 receives a PIN connectivity policy for PIN GW from the CN 1116 (e.g., as in operations 824 and 826 of FIG. 8). In some embodiments, the PIN connectivity policy for PIN GW may include the PIN type. In some embodiments, the PIN connectivity policy for PIN GW includes a CN connectivity parameter.

At 1124, the PIN GW 1114 communicates (e.g., sends a message indicating) security parameters for local connectivity to the PEMC 1112.

At 1126, the PEMC 1112 communicates (e.g., sends a message indicating) the availability of local connectivity to the PIN element 1110. The PEMC 112 may broadcast this information (e.g., to all PIN elements in the PIN). The communication may indicate PIN ID, PIN type, PIN GW ID, connectivity type and/or security parameters, etc., for local connectivity.

At 1128, the PIN element 1110 performs a discovery procedure and selects a PIN GW according to the received PIN GW's ID.

At 1130, the PIN element 1110 communicates (e.g., sends a message indicating) a local connectivity request to the PIN GW 1114. In some embodiments, the communication indicates a PIN ID, PIN type, PIN element's ID, and/or data delivery type. In some embodiments, the local connectivity request may be protected by security parameters for local connectivity.

At 1132, the PIN GW 1114 communicates (e.g., sends a message indicating) a local connectivity response to the PIN element 1110. In some embodiments, the communication indicates connectivity status (e.g., available or not available) of the local connectivity.

At 1134, the PIN GW may communicate (e.g., send a message indicating) a PIN element report to the core network 1116. The communication may indicate a PIN ID, PIN element's ID, IP address used by the PIN element and/or PIN element's RAT, etc.

At 1136, when receiving traffic 1135 from the PIN element, the PIN GW 1114 forwards the traffic 1137 (e.g., traffic for CN), such as 5G traffic to the CN 1116 via the control plane or user plane, e.g., based on data delivery type.

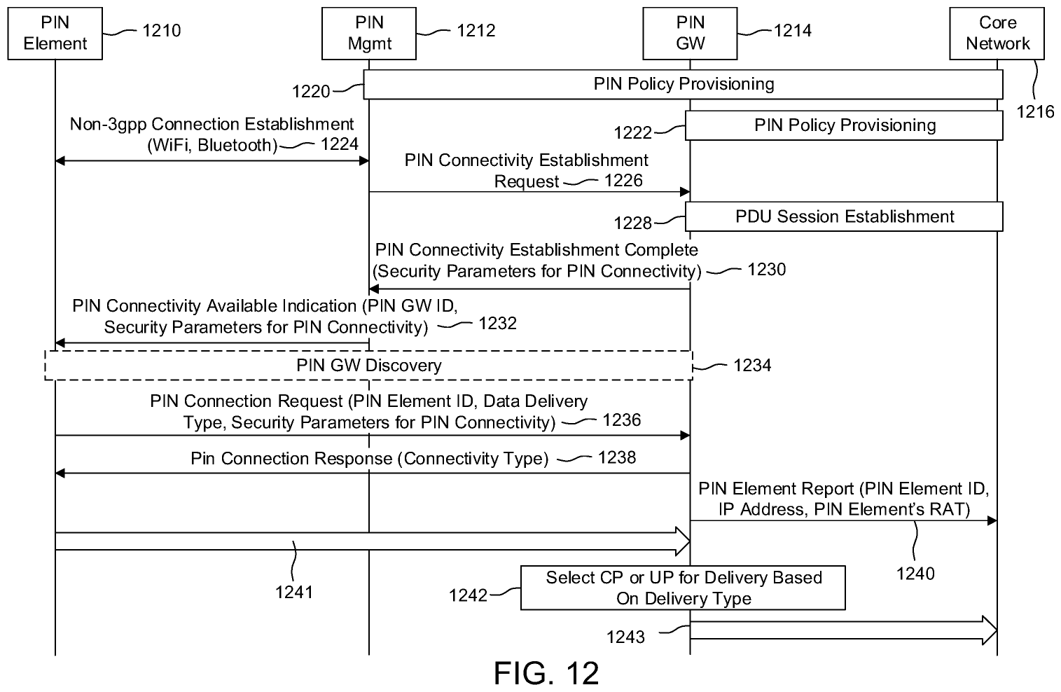

FIG. 12 is a sequence chart illustrating example communications for connectivity establishment between a PIN element 1210, A PIN management element (PEMC) 1212, a PIN GW 1214 and a core network 1216.

At 1220, the PEMC 1212 receives a PIN connectivity policy for PIN management (e.g., as in operations 820 and 822 in FIG. 8). In some embodiments, the provisioning occurs between PEMC 1212 and the CN (e.g., 5G CN) 1216 without the involvement of the PIN GW 1214. In some embodiments, the PIN connectivity policy for PIN management may include the PIN type. In some embodiments, the PIN connectivity policy for PIN management does not include a CN connectivity parameter.

At 1222, the PIN GW 1214 receives the PIN connectivity policy for PIN GW from the CN 1216 (e.g., as in operations 824 and 826 of FIG. 8). In some embodiments, the PIN connectivity policy for the PIN GW 1214 may include the PIN type. In some embodiments, the PIN connectivity policy for the PIN GW includes a CN connectivity parameter.

At 1224, a PIN element 1210 may establish a connection with the PEMC 1212. The connection may be any suitable connection, such as a Bluetooth or WiFi connection. Operation 1224 is performed after operation 1220 in some embodiments. Some operations or elements may be optional in some embodiments. For example, in some embodiments, the PEMC 1212 may create a PIN context locally and request PIN GW to establish connectivity for the PIN, and then PEMC waits for PIN elements to join. In another embodiment, after a PIN element joins the PIN, the PEMC 1212 requests the PIN GW 1214 to establish connectivity. Those of skill in the art will understand that various orderings of these steps are contemplated.

In some embodiments, the PEMC 1212 determines to create a PIN and determines the PIN type. The PEMC 1212 may validate whether the PIN type is allowed (e.g., per the PIN connectivity policy), whether a number of PIN elements to be included in the PIN has reached a PIN size limitation, whether a PIN duration has expired etc. Creating the PIN may include determining and/or storing PIN context information (e.g., PIN ID, list of PIN elements, PIN types, and so forth).

At 1226, the PEMC 1212 communicates (e.g., sends a message indicating) a PIN connectivity establishment request to the PIN GW 1214. The communication may indicate the PIN ID and PIN type for the PIN to be created. The communication may indicate a number of PIN elements, a PIN elements ID list, and/or a PIN duration, etc.

At 1228, the PIN GW 1214 determines to establish or modify CN connectivity for the PIN according to the connectivity type of the PIN type indicated in the message of operation 1226. The PIN GW 1214 retrieves CN connectivity parameters for the PIN type according to the corresponding PIN connectivity policy. In some embodiments, the PIN GW 1214 communicates (e.g., sends a message indicating) a CN connectivity establishment or modification request to the core network. The communication may indicate, e.g., a PDU session establishment or modification request. The communication may indicate, e.g., a PIN ID, a PIN type of the PIN, and/or a number of PIN elements. In some embodiments, the core network communicates (e.g., sends a message indicating) a CN connectivity establishment or modification response to the PIN GW. The communication may include, e.g., a PDU session establishment and/or modification response.

At 1230, the PIN GW 1214 communicates (e.g., sends a message indicating) security parameters for local connectivity to the PEMC 1212.

At 1232, the PEMC 1212 communicates (e.g., sends a message indicating) the availability of local connectivity to the PIN element 1210. The PEMC 1212 may broadcast this information (e.g., to all PIN elements in the PIN). The communication may indicate PIN ID, PIN type, PIN GW ID, connectivity type and/or security parameters, etc., for local connectivity.

At 1234, the PIN element 1210 performs a discovery procedure and selects a PIN GW according to the received PIN GW's ID. PIN GW discovery and selection may include, e.g., proximity discovery. For example, the PIN GW 1214 may broadcast an announcement message (e.g., including a PIN GW ID in the announcement message) over a radio interface. A PIN element in proximity range may receive this announcement message. The PIN element may be considered to have discovered the PIN GW after having received the announcement message. If the PIN element has discovered multiple PIN GWs, the PIN element may select one PIN GW to access.

At 1236, the PIN element 1210 communicates (e.g., sends a message indicating) a local connectivity request to the PIN GW 1214. In some embodiments, the communication indicates a PIN ID, PIN type, PIN element's ID, and/or data delivery type. In some embodiments, the local connectivity request may be protected by security parameters for local connectivity.

At 1238, the PIN GW 1214 communicates (e.g., sends a message indicating) a local connectivity response to the PIN element. In some embodiments, the communication indicates connectivity status (e.g., available or not available) of the local connectivity.

At 1240, the PIN GW 1214 may communicate (e.g., send a message indicating) a PIN element report to the core network 1216. The communication may indicate a PIN ID, PIN element's ID, IP address used by the PIN element and/or PIN element's RAT, etc.

At 1242, when receiving traffic 1241 from the PIN element, the PIN GW 1214 forwards the traffic 1243 (e.g., traffic for CN, such as 5G traffic) to the CN via the control plane or user plane, e.g., based on data delivery type.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A wireless transmit/receive unit (WTRU) comprising circuitry configured to:
send a personal internet of things (PIN) policy request to a core network (CN), wherein the PIN policy request indicates a PIN manager capability;
receive a PIN policy from the CN, which indicates authorized PIN types;
send a personal internet of things (PIN) connectivity policy request to the CN, wherein the PIN connectivity policy request indicates a PIN gateway (GW) capability of the WTRU;
receive PIN connectivity policy information from the CN, based on the PIN GW capability, wherein the PIN connectivity policy information indicates traffic forwarding parameters, a data network name (DNN), slice information, and an indication whether the WTRU can provide local connectivity, core network connectivity, or both;
receive a PIN connectivity establishment request from a PIN element;
based on the PIN connectivity establishment request from the PIN element and based on a condition that the policy PIN connectivity policy information indicates that the WTRU can provide core network connectivity, establish a connection with the CN based on the DNN and the slice information; and
forward data between the CN and the PIN element, via the connection, based on the traffic forwarding parameters.

2. The WTRU of claim 1, wherein the WTRU comprises a PIN GW.

3. The WTRU of claim 1, wherein the PIN connectivity policy information indicates at least one authorized PIN type, at least one connectivity type, and/or at least one CN connectivity parameter.

4. The WTRU of claim 3, wherein the at least one CN connectivity parameter includes at least one of: a Public Land Mobile Network (PLMN) identity (ID), service and session continuity (SSC) mode, packet data unit (PDU) session type, data delivery mode, and data transmission frequency.

5. The WTRU of claim 1, wherein the PIN element comprises a PIN manager.

6. The WTRU of claim 1, further comprising circuitry configured to receive local connectivity parameters for the PIN from the CN, and to send the local connectivity parameters to a PIN Manager.

7. The WTRU of claim 6, wherein the local connectivity parameters indicate an L2 or L3 relay, an end point identifier, and/or an inter-radio access technology (RAT) communication policy.

8. The WTRU of claim 1, further comprising circuitry configured to receive security parameters for the PIN from the CN, and to send the security parameters to a PIN Manager.

9. The WTRU of claim 8, wherein the security parameters comprise security parameters for local connectivity.

10. The WTRU of claim 1, wherein the PIN policy further comprises a PIN size or a PIN duration.

11. A method implemented by a wireless transmit/receive unit (WTRU) comprising:
sending a personal internet of things (PIN) policy request to a core network (CN), wherein the PIN policy request indicates a PIN manager capability;
receiving a PIN policy from the CN which indicates authorized PIN types;
sending a personal internet of things (PIN) connectivity policy request to the CN, wherein the PIN connectivity policy request indicates a PIN gateway (GW) capability of the WTRU;
receiving PIN connectivity policy information from the CN, based on the PIN GW capability, wherein the PIN connectivity policy information indicates traffic forwarding parameters, a data network name (DNN), and slice information, and an indication whether the WTRU can provide local connectivity, core network connectivity, or both;
receiving a PIN connectivity establishment request from a PIN element;
based on the PIN connectivity establishment request from the PIN element and based on a condition that the policy PIN connectivity policy information indicates that the WTRU can provide core network connectivity, establishing a connection with the CN based on the DNN and the slice information; and
forwarding data between the CN and the PIN element, via the connection, based on the traffic forwarding parameters.

12. The method of claim 11, wherein the WTRU comprises a PIN GW.

13. The method of claim 11, wherein the PIN connectivity policy information indicates at least one authorized PIN type, at least one connectivity type, and/or at least one CN connectivity parameter.

14. The method of claim 13, wherein the at least one CN connectivity parameter includes at least one of: a Public Land Mobile Network (PLMN) identity (ID), service and session continuity (SSC) mode, packet data unit (PDU) session type, data delivery mode, and data transmission frequency.

15. The method of claim 11, wherein the PIN element comprises a PIN manager.

16. The method of claim 11, further comprising receiving local connectivity parameters for the PIN from the CN, and sending the local connectivity parameters to a PIN Manager.

17. The method of claim 16, wherein the local connectivity parameters indicate an L2 or L3 relay, an end point identifier, and/or an inter-radio access technology (RAT) communication policy.

18. The method of claim 11, further comprising receiving security parameters for the PIN from the CN, and sending the security parameters to a PIN Manager.

19. The method of claim 18, wherein the security parameters comprise security parameters for local connectivity.

20. The method of claim 11, wherein the PIN policy further comprises a PIN size or a PIN duration.
